(19) United States
(12) Patent Application Publication
(10) Pub. No.: US 2021/0352979 A1
(43) Pub. Date: Nov. 18, 2021

(54) Adjustable disposable face mask

(71) Applicant: Love Your Melon Inc., Minneapolis, MN (US)

(72) Inventors: Zachary Quinn, St. Mary's Point, MN (US); Brian Keller, Minneapolis, MN (US); Charles Carlisle, Minneapolis, MN (US); Chloe Cunagin, St. Louis Park, MN (US); Regena Yu, Minneapolis, MN (US); Jacqueline Lee, Minneapolis, MN (US); Robert Bosworth, Hudson, WI (US); Abraham Jacob, Arden Hills, MN (US)

(21) Appl. No.: 16/872,972

(22) Filed: May 12, 2020

(51) Int. Cl. A41D 13/11; D06H 7/22

(52) U.S. Cl. CPC A41D 13/1107; A41D 13/1161; D10B 2201/02; D10B 2501/04; D06H 7/22

(57) ABSTRACT

An adjustable protective face covering having a first end having one or more openings spaced apart there along and a second opposing end having one or more openings spaced apart there along. A length extends therebetween for covering a mouth and nose of a wearer, and the face covering is a single use face covering that is a constructed from a unitary sheet comprised of surgical wrap, polypropylene, Spunbond Meltblown Spunbond (SMS), or cotton. The single component mask can be cut from sheets of substrate using various techniques including laser cutting, die cutting, or other machinery typically of use in clothing manufacture.

### BACKGROUND

This disclosure relates to protective face coverings and in particular it relates to face coverings that provide a barrier that inhibits particulates, airborne droplets or aerosols that may contain bacterial and/or viral matter from reaching the user's nasal and oral cavities.

Single use and disposable protective face coverings typically comprise a face covering portion secured to or sewn to straps that adjustably secure the face covering to a user. The straps generally tie around the back of the user's head or comprise an elastic material that stretches to extend around a user's ears. The multi-component assembly for each protective face masks increases the costs and time associated with production.

### SUMMARY

An aspect of the present disclosure relates to an adjustable protective face covering such as a face mask. The covering has a first end having one or more openings spaced apart there along and a second opposing end of similar construction and having one or more openings spaced apart there along. A protective length extends therebetween for covering a mouth and nose of a wearer. The face covering is a unitary sheet comprised of surgical wrap, polypropylene, Spunbond Meltblown Spunbond (SMS), or cotton.

The one or more openings of each of the first and second ends are substantially vertically positioned slits or openings configured and aligned to receive a wearer's ear therethrough. The openings are generally arcuate along their lengths.

The surgical wrap, polypropylene, Spunbond Meltblown Spunbond (SMS), or cotton material for producing the face covering is of a construction sufficient to protect a wearer from particulates, airborne droplets or aerosols that may contain bacterial and/or viral matter.

Additional areas of breathability are positioned at or near the first and second ends of the face covering.

In one or more embodiments the face covering is a continuous face covering, single or double layer in construction.

In one or more embodiments, the face covering is constructed of only polypropylene, Spunbond Meltblown Spunbond (SMS), or cotton.

The face covering does not comprise any elastic component or adhesive component.

Another aspect of the present disclosure relates to a method of making a single use adjustable face covering. To produce the face coverings, a perimeter of one or more face coverings is cut concurrently with automated fabric cutting machinery, a laser system, or a die cutter. A plurality of openings within the perimeter of the face covering are cut and are spaced apart from one another on a first end of the face covering. Similarly, a second plurality of openings within the perimeter of the face covering are cut and are spaced apart from one another on a second opposing end of the face covering. Cutting is carried out on a web or sheet of polypropylene, Spunbond Meltblown Spunbond (SMS), or cotton for making the adjustable face covering.

Printing, imprinting, cutting or otherwise providing at least one of text and an image on one or more surfaces of face covering provide customization to the single use adjustable face covering. One or more of the protective surfaces and the ends of the face covering can be marked in such a manner.

Cutting methods include but are not limited to machine cutting, die cutting, laser cutting or a combination thereof.

Yet another aspect of the present disclosure relates to a method of using an adjustable face covering. To use the adjustable face covering, a first opening in a plurality of spaced apart openings on a first portion of the face covering is aligned with a first ear of a wearer and the first selected opening placed around the ear to connect the first portion to the wearer. The protective surface or main portion of the face covering is wrapped across the wearer's face to cover the wearer's mouth and nose with the main portion of the face covering. A second opening in a second plurality of spaced apart openings on a second portion of the face covering is aligned with a second ear of a wearer and the second opening placed around the second ear to connect the second portion to the wearer. The face covering is a unitary and continuous sheet of material from the first portion to the main portion and to the second portion and is comprised of surgical wrap, polypropylene, Spunbond Meltblown Spunbond (SMS)(as described in U.S. published patent application US20060141886A1), or cotton.

Positioning a customizable visual display located on a main portion of the face covering outwardly allows for custom wearing. The face covering is then disposed of after use.

### BRIEF DESCRIPTION OF THE DRAWINGS

FIG. 1 is a front perspective view of an adjustable protective face mask.

FIG. 2 is a front view of the protective face mask.

FIG. 3 is a rear review of the protective face mask.

FIG. 4 is a side view of the protective face mask.

FIG. 5 is a top view of the protective face mask.

FIG. 6 is a perspective front view of the adjustable protective face mask in use.

FIG. 7 is an additional perspective front view of the protective face mask in use.

### DETAILED DESCRIPTION

An adjustable protective face mask or covering is provided as a single piece device. That is, there are no elastic straps or other fasteners such as adhesives or hook and loop fasteners secured to or otherwise provided to the covering in order to wear the protective face mask or covering. A single sheet is cut to a shape which provides coverage to a wearer's face including the mouth and nose, to protect the wearer from particulates, airborne droplets or aerosols that may contain bacterial and/or viral matter.

The sheet is further cut to provide a plurality of spaced apart openings on opposing edge portions of the face covering. These openings provide adjustability to the face covering by way of extending or reducing a length of a face protective surface of the covering depending on selection of an opening on each opposing edge portion used to secure the covering to the wearer.

The face covering described herein is constructed from the same material generally used in surgical wraps, can be constructed from sterilization wrap, cotton and other fabric materials which provide breathable protection to a wearer. As such, the adjustable face covering described herein can be disposable or reusable.

The adjustable face covering described herein can also be provided in adult and child sizes, with a standard overall length and a plurality of mounting openings which allow the same mask to be used comfortable by adults of different sizes and children of different ages, for example.

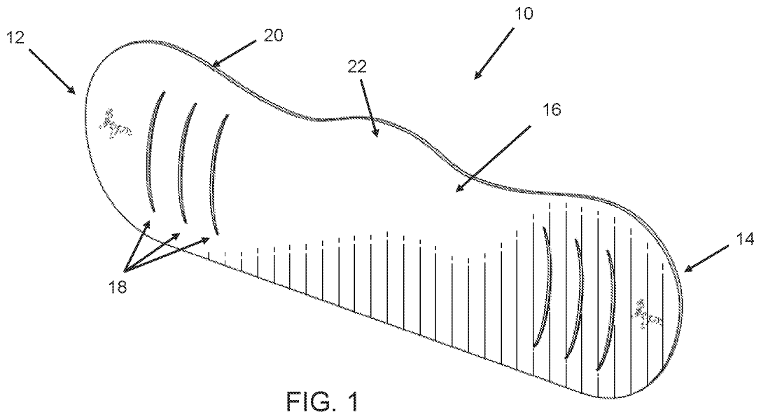

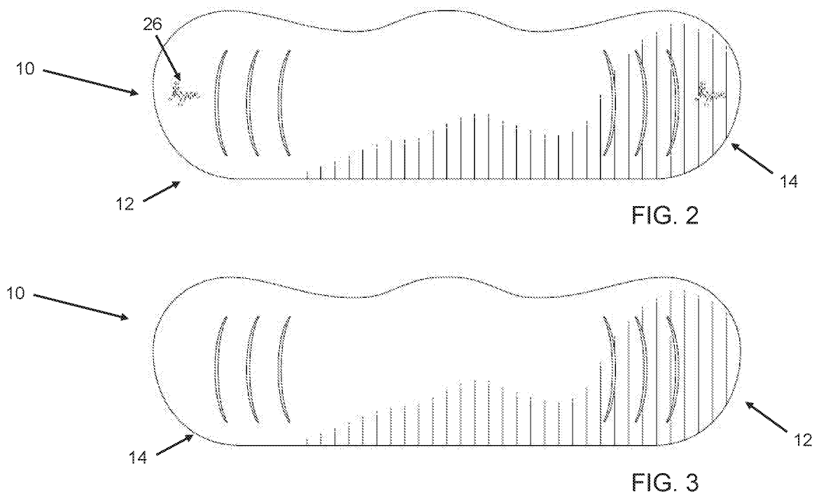

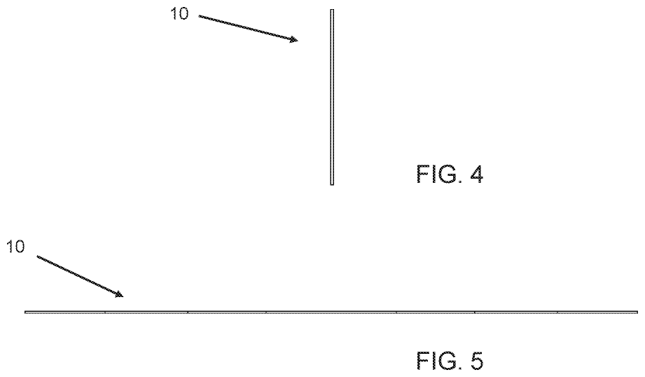

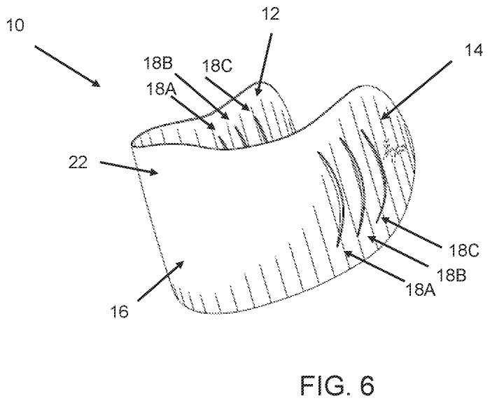

A protective face covering 10 is illustrated in FIGS. 1-7. As illustrated in FIG. 1, the face covering 10 has a first end 12 and a second end 14 with a protective surface 16 extending therebetween. The first end 12 and second end 14 are each configured for attaching securely and easily to a wearer, generally via a wearer's ears. Each end 12 and 14 is provided with a plurality of openings 18, such as slits, which are spaced apart along terminal portions of each end 12 and 14. The protective surface 16 is a length of the face covering 10 extending between these ends 12 and 14. The protective surface 16 is integral to the ends 12 and 14, for example, the mask is constructed form a single section or sheet of material and is a single piece face covering 10. The protective surface 16 may also comprise a nosepiece 22 which is an outward or upward extension along the length of the protective surface 16 for covering a wearers nose.

A perimeter 20 to the face covering 10 is cut from a web or sheet of material to provide the overall shape to the face covering 10. In the embodiment illustrated, the ends 12 and 14 extend outwardly from a middle section, the protective surface 16. The ends 12 and 14 may be symmetrically formed and may have a rounded perimeter shape. The ends 12 and 14 may be wider at an area of the ends 12 and 14 that would be proximate a wearer's ears when worn and less wide at a length that corresponds to a side of the wearer's face or cheek. The protective surface 16 has dimensions sufficient to provide covering of a wearer's nose and mouth and to extend for coverage from proximate the chin to a location above a wearer's nostrils and thus covering the wearer's nose and nasal cavity.

The protective surface 16 is configured to wrap around the wearer's face when the ends 12 and 14 are attached to the wearer. For example, the length of the protective surface 16 is adjustable to provide a snug fit around the wearer's mouth and nose for example, by way of selection of one of the plurality of openings 18 on each end 12 and 14. That is, terminal openings 18C provide a larger face covering 10 when worn by providing a greater length to the protective surface 16 than when proximal openings 18A are used for wearing. A mid length can be selected by use of the inner openings 18B. While three openings are provided on each end 12 and 14, greater or fewer openings are contemplated and within the scope of this disclosure.

The openings 18A, 18B, 18C in the illustrated embodiments are substantially vertical in position with an arcuate or otherwise curved length and are formed along a portion of the height of the respective end 12 or 14. The openings 18A, 18B, 18C may be parallel in form and spaced apart at the same or different distances between opening 18A and 18B and 18B and 18C. The size of the openings 18A, 18B, 18C are sufficient to allow a wearer's ear to be inserted into and through the opening so that the respective end 12 or 14 is then attached to the wearer via the selected opening for use.

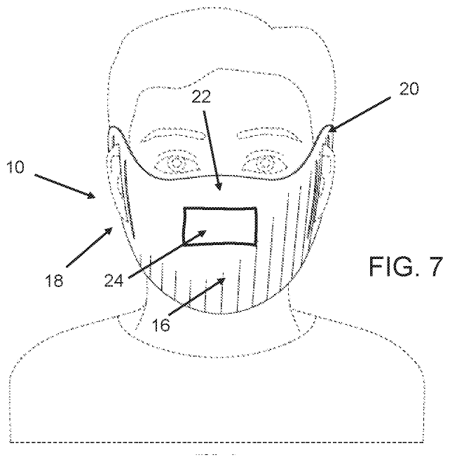

In one embodiment, as illustrated in FIG. 7, the face covering 10 has dimensions allowing the face covering 10 to be a one-size fits most face covering 10 for adults. The openings 18A, 18B, and 18C are generally evenly spaced apart from one another on each of the first end 12 and second end 14 of the covering 10. For example, there is a spacing of about 0.95 inches between each two adjacent openings such as between opening 18A and 18B and similarly between openings 18B and 18C. The dimensions of the face covering 10 are reduced to provide a one-size fits most face covering 10 for children.

The face covering 10 can be cut from a web or sheet of material such as surgical wrap, polypropylene, Spunbond Meltblown Spunbond (SMS) material of the type generally used in sterilization wraps, or 100% cotton. Alternative materials can include but are not limited to polytetrafluoroethylene (Gore-Tex®), antimicrobial fabrics, silver laced fabrics, spandex and combinations thereof.

The face covering 10 has a shape and size such that the face covering 10 can be produced in high volume using automated fabric cutting machinery common in apparel manufacturing environments. For example, the face covering 10 is constructed from a single layer of material and is formed from and as a single component device. When a die cutting process is used for producing the face covering 10, the face covering may be formed as a double layer face covering 10 still as a single component face mask formed from two layers of material stacked. When a double layer is used to produce the face covering 10, the layers are stacked and secured together using traditional means such as stitched seams.

The face covering 10 can also be formed with laser cutting devices. Manufacture of a high volume of the adjustable face covering 10 is additionally feasible as the coverings 10 are a single unit or single-component covering 10 as formed. That is, there are additional pieces to assembly to form the covering 10 and no other attachment mechanisms are incorporated into the coverings 10. As such, the covering 10 eliminates the use of fasteners such as elastic pieces, hook and loop fasteners or adhesives. Instead, small openings are strategically formed and spaced apart on the ends of the face covering 10 which provide adjustable mechanisms for attaching the covering 10 to a wearer.

In one or more embodiments, the face covering 10 is a single-use, disposable face covering or mask. For example, materials such as surgical wrap or sterilization wrap provide a protective and disposable face covering for one-time use.

In one or more embodiments, the face covering 10 is customizable. For example, any surface of the face covering 10 such as the protective surface 16 may be imprinted, printed, or otherwise marked on an outer face with first content 24 such as a third-party logo, or other content such as text and/or images. Additionally, or alternatively, ends 12 and/or 14 of the face covering 10 may be printed, imprinted or cut with second content 26 such as a label, text and/or images.

In one or more embodiments, the face covering is also adjustable such that the face covering can be worn with additional face protection, such as in addition to or over a second protective face covering.

Although the present disclosure has been described with reference to preferred embodiments, workers skilled in the art will recognize that changes may be made in form and detail without departing from the spirit and scope of the disclosure.

1. An adjustable protective face covering comprising:
a first end having one or more openings spaced apart there along;
a second opposing end having one or more openings spaced apart there along; and
a length extending therebetween for covering a mouth and nose of a wearer,
wherein the face covering is a unitary sheet comprised of surgical wrap, polypropylene, Spunbond Meltblown Spunbond (SMS), or cotton.

2. The adjustable face covering of claim 1, wherein the one or more openings of each of the first and second ends are substantially vertical slits or openings configured to receive a wearer's ear therethrough.

3. The adjustable face covering of claim 1 wherein the polypropylene, Spunbond Meltblown Spunbond (SMS), or cotton are sufficient to protect a wearer from airborne droplets or particulates.

4. The adjustable face covering of claim 1 and comprising areas of breathability positioned at or near the first and second ends of the face covering.

5. The adjustable face covering of claim 1 where in the covering is a continuous, single layer of material.

6. The adjustable face covering of claim 1 and wherein the face covering is constructed of only polypropylene, Spunbond Meltblown Spunbond (SMS), or cotton.

7. The adjustable face covering of claim 1 and wherein the face covering does not comprise any elastic component or adhesive component.

8. A method of making an adjustable face covering comprising:
cutting a perimeter of one or more face coverings concurrently with automated fabric cutting machinery, a laser system, or a die cutter;
cutting a plurality of slits spaced apart from one another on a first end of the face covering; and
cutting a second plurality of slits spaced apart from one another on a second opposing end of the face covering.

9. The method of claim 8, wherein cutting comprising cutting a sheet of polypropylene, Spunbond Meltblown Spunbond (SMS), or cotton for making the adjustable face covering.

10. The method of claim 8, and further comprising printing, imprinting or otherwise providing at least one of text and an image on a protective surface of the face covering.

11. The method of claim 8 wherein cutting comprises machine cutting, die cutting, laser cutting or a combination thereof.

12. A method of using an adjustable face covering comprising:
aligning a first opening in a plurality of spaced apart openings on a first portion of the face covering with a first ear of a wearer and placing the first opening around the ear to connect the first portion to the wearer;
wrapping a main portion of the face covering across the wearer's face to cover the wearer's mouth and nose with the main portion of the face covering; and
aligning a second opening in a second plurality of spaced apart openings on a second portion of the face covering with a second ear of a wearer and placing the second opening around the second ear to connect the second portion to the wearer;
wherein the face covering is a unitary and continuous sheet of material from the first portion to the main portion and to the second portion and is comprised of surgical wrap, polypropylene, Spunbond Meltblown Spunbond (SMS), or cotton.

13. The method of claim 12 and positioning a customizable visual display located on a main portion of the face covering outwardly and disposing of the face covering after use.
